(19) United States
(12) Patent Application Publication
(10) Pub. No.: US 2026/0005459 A1
(43) Pub. Date: Jan. 1, 2026

(54) ELECTRICAL CONNECTOR WITH TERMINAL POSITION ASSURANCE

(71) Applicant: Aptiv Technologies AG, Schaffhausen (CH)

(72) Inventors: Uvaraj GANESAN, Tamil Nadu (IN); Romain SAVINA, Saint Martin de Bréthencourt (FR); Sylvain LOAS, Le Gault Saint Denis (FR); Laurent DELESCLUSE, SAINT PIAT (FR); Tanmay H. MUDUGAL, Bengaluru (IN)

(21) Appl. No.: 19/250,557

(22) Filed: Jun. 26, 2025

(30) Foreign Application Priority Data
Jun. 28, 2024 (EP) 24185219.3

(51) Int. Cl. H01R 13/436; H01R 13/02; H01R 13/50

(52) U.S. Cl. CPC H01R 13/4361; H01R 13/02; H01R 13/501

(57) ABSTRACT

An electrical connector includes a housing defining a chamber with a top wall, bottom wall, and side walls arranged to form multiple locations, each configured to receive one electrical terminal along a reception direction. Each electrical terminal has opposing first and second surfaces with corresponding first and second locking holes. Within each location, a latch extends over the bottom wall and cooperates with both locking holes to secure the terminal in the reception direction. The top wall features an opening through which a retainer is pivotally mounted about an axis parallel to the side walls. The retainer moves between a locked position, engaging the opening and holding the terminals via protrusions that engage both locking holes, and an unlocked position, disengaged from the opening, thereby securing the set of electrical terminals in the first direction within the housing.

### CROSS-REFERENCE TO RELATED APPLICATION

This application claims the benefit of and priority to European Application No. 24185219.3 filed with the European Patent Office on Jun. 28, 2024, the contents of which are incorporated by reference herein.

### TECHNICAL FIELD

The present disclosure generally relates to electrical connectors, specifically to electrical connectors with terminal position assurance (TPA) members.

### BACKGROUND

In the automotive industry, connectors are subjected to vibrations, mechanical stresses, and environmental factors that can compromise the integrity of electrical connections. It is further of utmost importance that all electrical terminals are correctly mounted in their respective connector housing. Traditional connectors often lack adequate mechanisms to ensure that terminals are properly seated and locked in place, leading to potential misconnections, disconnections, signal loss, or electrical failures. To mitigate these issues, Terminal Position Assurance (TPA) members have been developed. TPAs provide additional security by verifying the correct mounting of terminals and/or by (additionally) locking terminals in position, ensuring they do not move or dislodge from the connector housing. However, existing TPA designs may still face challenges, such as complexity in assembly and difficulty in ensuring precise terminal positioning. It is thus an object of the present disclosure to provide an improved TPA member.

### SUMMARY

An aspect of the disclosure relates to an electrical connector assembly, including a connector housing configured to receive a plurality of terminals; a first and a second terminal position assurance (TPA) member (also denoted herein as TPA). The first and the second TPA are configured to be mounted to the connector housing and being movable relative to the connector housing between a pre-lock position and a final-lock position; a terminal header arranged in the connector housing including a first region having a first pitch between the terminals and a second region having a second pitch, wherein the first pitch is larger than the second pitch, where the first TPA is associated with the first region and the second TPA is associated with the second region.

This disclosure aims to completely or partly overcome the aforementioned drawbacks. To this end, one aspect of the disclosure is an electrical connector having a set of electrical terminals. Each electrical terminal includes opposed first and second surfaces defining first and second locking holes, respectively. The electrical connector also includes a housing having a chamber arranged to receive the set of electrical terminals along a reception direction. The chamber has a top wall, a bottom wall, and side walls. The side walls are arranged successively inside the chamber in a first direction perpendicular to the reception direction to define the locations. Each location is dedicated to one electrical terminal of the set. The top wall has an opening arranged to allow access to the locations. Each location has a latch designed to cooperate with both the first and second locking holes to hold the corresponding electrical terminal in position along the reception direction. The latch extends over the bottom wall in the corresponding location. The electrical connector further contains a retainer that is pivotally mounted on the top wall about a rotating axis parallel to the first direction and is movable between a locked position in which the retainer is engaged in the opening and an unlocked position, in which the retainer is disengaged from the opening. The retainer has protrusions that are designed to cooperate with both the first and second locking holes so that the retainer holds the set of electrical terminals in the first direction in position in the locked position.

Thus, such an electrical connector according to the disclosure makes it possible to provide terminal position assurance, including when an electrical terminal is inserted in the chamber by rotating 180° around a horizontal axis while retaining an operating utility. This is made possible by combining:
i. The latch which is designed to cooperate with the first locking hole when the electrical terminal is inserted in the chamber (e.g. usual direction of use), and to cooperate with the second locking hole when the electrical terminal is inserted in the chamber by rotating 180° around a horizontal axis (second direction of use); and
ii. The protrusions of the retainer are designed to cooperate with the second locking hole when the electrical terminal is inserted in the chamber and to cooperate with the first locking hole when the electrical terminal is inserted in the chamber by rotating 180° around a horizontal axis.
iii. In other words, an electrical terminal is held in position within the corresponding location by the latch and by a protrusion of the retainer regardless of the direction of use (without rotation or with a 180° rotation around a horizontal axis).

The electrical connector according to the disclosure may include one or more of the following features.

According to one feature of the disclosure, the protrusions are arranged to face the latches when the retainer is in the locked position. Thus, one advantage provided is enhancement of the mechanical stability, security, and durability of the electrical connector.

According to one feature of the disclosure, the protrusions are at a distance from the latches when the retainer is in the locked position. Thus, one advantage provided is improvement of vibration resistance of the electrical connector.

According to one feature of the disclosure, the protrusions have a rectangular cross-section along the reception direction when the retainer is in the locked position. Thus, one advantage provided is simplification of design and increased retention force.

According to one feature of the disclosure, the retainer is elastically deformable to allow bending about the rotating axis between the locked position and the unlocked position. Thus, one advantage provided is that elastically deformable materials can be chosen for their resistance to temperature extremes and moisture, ensuring reliable performance in diverse environmental conditions. Moreover, an elastic retainer can absorb vibrations and shocks better than a rigid retainer, maintaining a secure connection in environments subject to mechanical disturbances.

According to one feature of the disclosure, the top wall includes a supporting edge, and the retainer includes a shoulder arranged to rest against the supporting edge when the retainer is in the locked position. Thus, one advantage provided is that the interaction between the shoulder and the supporting edge adds mechanical strength to the locking mechanism, making the connection more robust.

According to one feature of the disclosure, the latch equipping each location includes a guiding surface, arranged on the bottom wall to guide the corresponding electrical terminal along the reception direction and a stop element, arranged on the guiding surface to cooperate with both the first and second locking holes so as to lock the corresponding electrical terminal in translation along the reception direction Thus, one advantage provided is to ensure correct installation of the electrical connector within the corresponding location.

According to one feature of the disclosure, the guiding surface has a raising slope toward the reception direction. Thus, one advantage provided is that the sloped guiding surface helps to automatically align the electrical terminal as it is inserted, correcting minor misalignments, and ensuring proper engagement.

According to one feature of the disclosure each electrical terminal of the set extends along a longitudinal axis and the first and second locking holes of each electrical terminal have a rectangular longitudinal section along the longitudinal axis. Thus, one advantage provided is prevention of the electrical terminals from rotating within the housing and ensuring that the alignment remains consistent.

According to one feature of the disclosure, the chamber includes opposing first and second ends along the reception direction, the first end is a reception end designed to receive the set of electrical terminals, and the second end is a mating end designed to mate the set of electrical terminals with corresponding terminals.

According to one feature of the disclosure, the set of electrical terminals includes a first and a second subset of electrical terminals. Each electrical terminal of the first subset is held in position in the reception direction by the corresponding latch cooperating with the first locking hole, each electrical terminal of the second subset is held in position in the reception direction by the corresponding latch cooperating with the second locking hole. The retainer in the locked position holds in position the first subset of electrical terminals in the first direction by the protrusions cooperating with the second locking holes. The retainer in the locked position holds in position the second subset of electrical terminals in the first direction by the protrusions cooperating with the first locking holes.

### BRIEF DESCRIPTION OF THE DRAWINGS

In the following, preferred embodiments of the disclosure are disclosed by reference to the accompanying figure, in which shows:

FIG. 1 is an exploded view of an electrical connector illustrating two electrical terminals (one of which is inserted in the chamber by rotating 180° around a horizontal axis) and a retainer in an unlocked position according to some embodiments.

FIG. 2 is an isometric view of an electrical terminal, extending in a usual first insertion direction according to some embodiments.

FIG. 3 is an isometric view of the electrical terminal shown in FIG. 2, extending in a second insertion direction by rotating 180° around a horizontal axis from the first usual insertion direction according to some embodiments.

FIG. 4 is a partial isometric view of an electrical connector in the absence of electrical terminals inside the chamber, the retainer being in an unlocked position according to some embodiments.

FIG. 5 is a schematic view at enlarged scale of a retainer of an electrical connector in an unlocked position according to some embodiments.

FIG. 6 is a partial isometric view of an electrical connector according to some embodiments with one side part having been removed (for illustrative purposes) to illustrate the interior of a location intended to receive an electrical terminal. The retainer is in an unlocked position.

FIG. 7 is an isometric view of an electrical connector according to some embodiments with electrical terminals inside the chamber, the retainer being in an unlocked position.

FIG. 8 is a front view (on the side of the mating end) of an electrical connector according to the invention, the retainer being in a locked position according to some embodiments.

FIG. 9 is a partial isometric view of an electrical connector according to some embodiments with one side part having been removed (for illustrative purposes) to illustrate the interior of a location receiving an electrical terminal. Half of the electrical terminal has been removed for illustrative purposes. The retainer is in an unlocked position.

FIG. 10 is a similar view to FIG. 9, the retainer being in a locked position according to some embodiments.

FIG. 11 is a partial isometric view of an electrical connector according to some embodiments with one half having been removed (for illustrative purposes) to illustrate the interior of a central location receiving an electrical terminal. Half of the electrical terminal has been removed for illustrative purposes. The retainer is in an unlocked position.

FIG. 12 is a partial isometric view of an electrical connector according to some embodiments with a majority having been removed (for illustrative purposes) to illustrate the interior of a peripheral location receiving an electrical terminal. Half of the electrical terminal has been removed for illustrative purposes. The retainer is in a locked position.

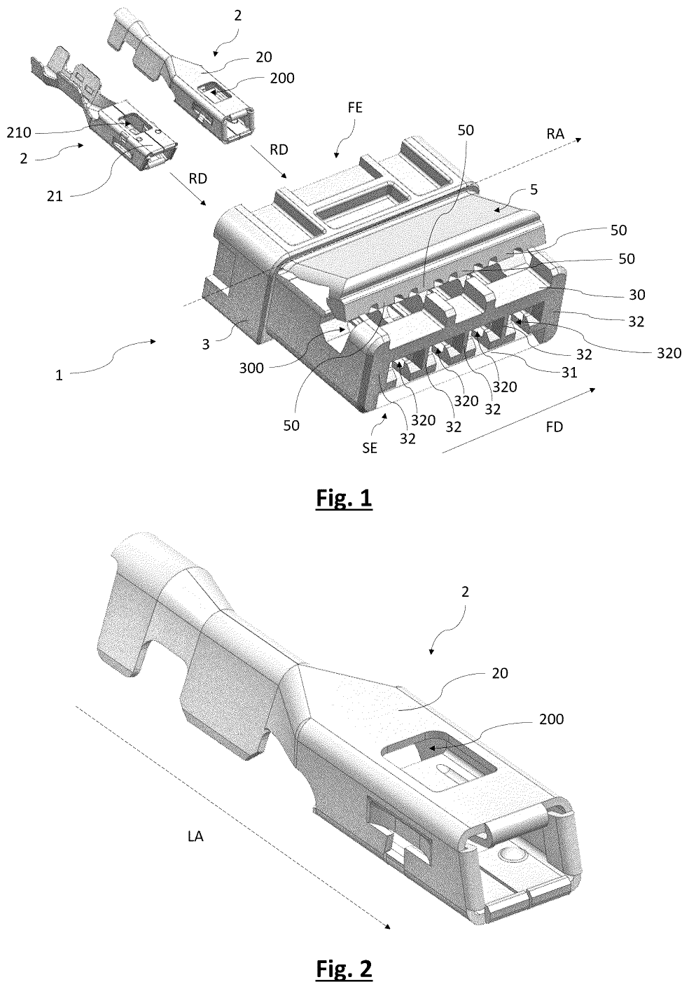

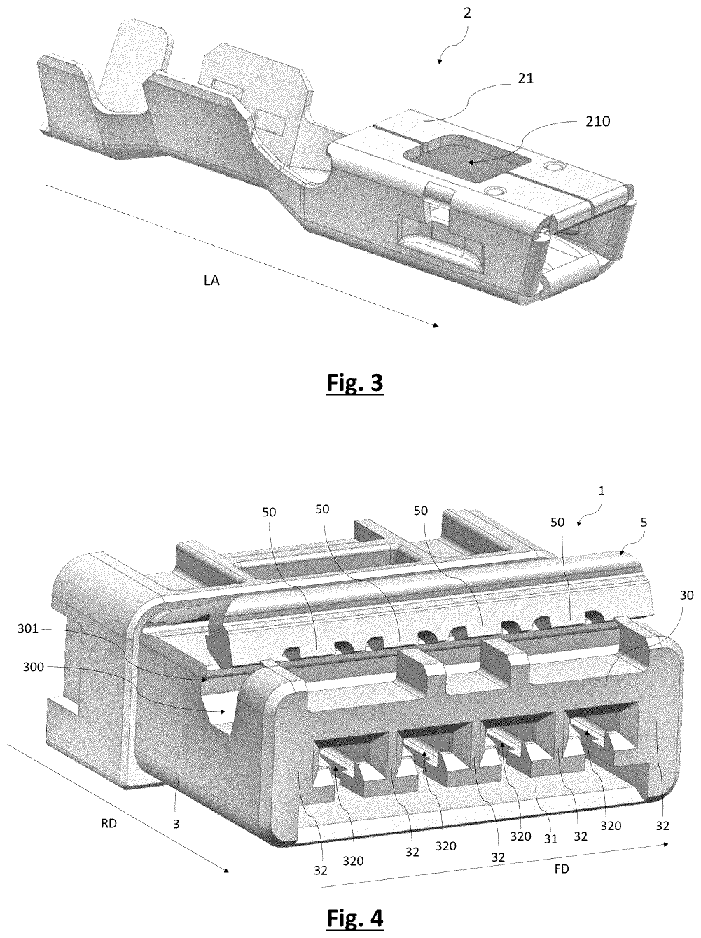

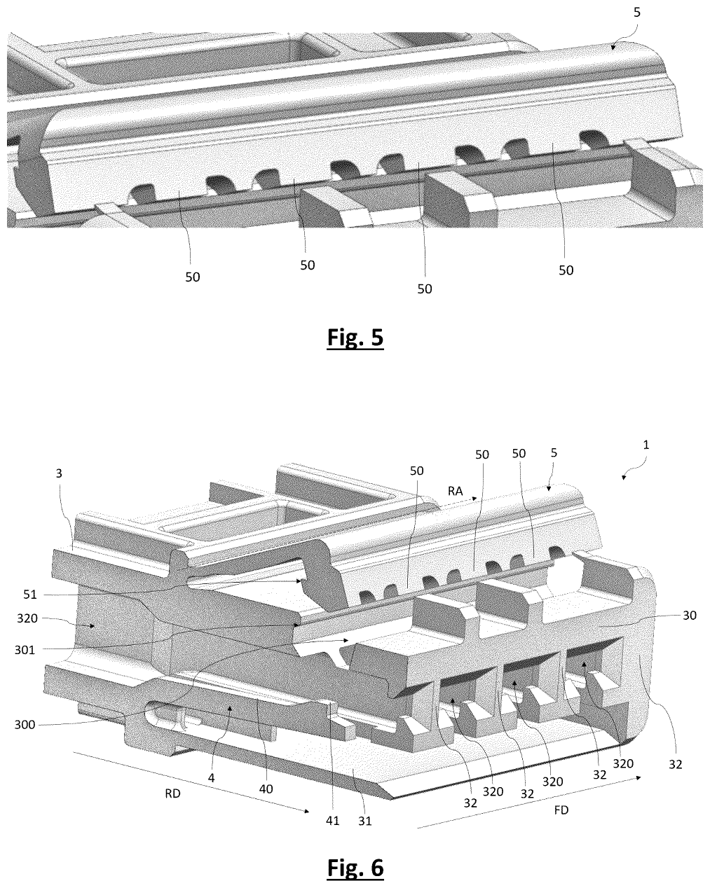

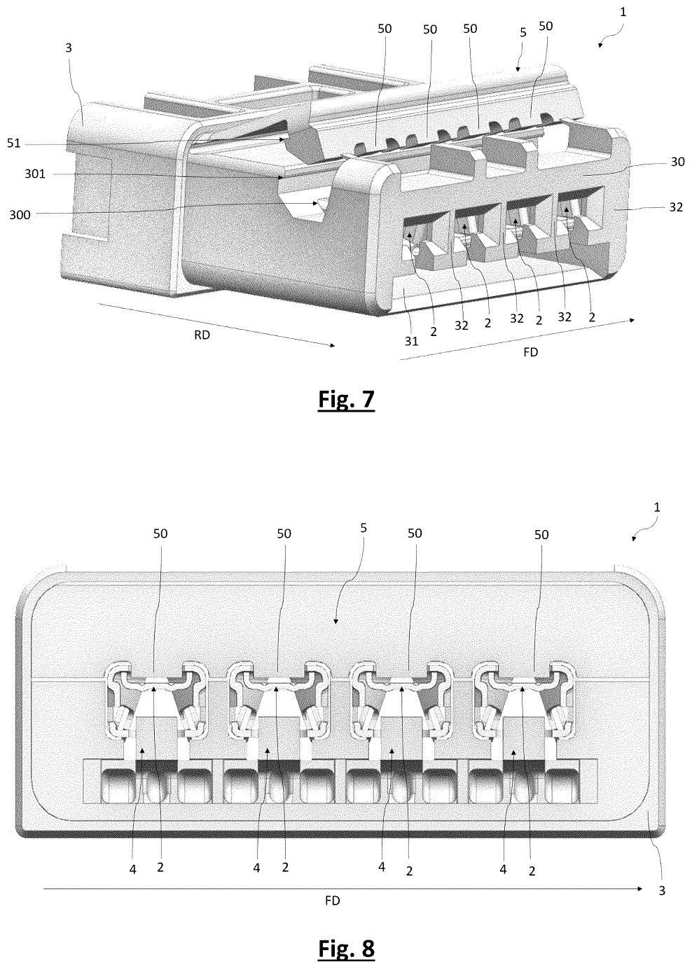

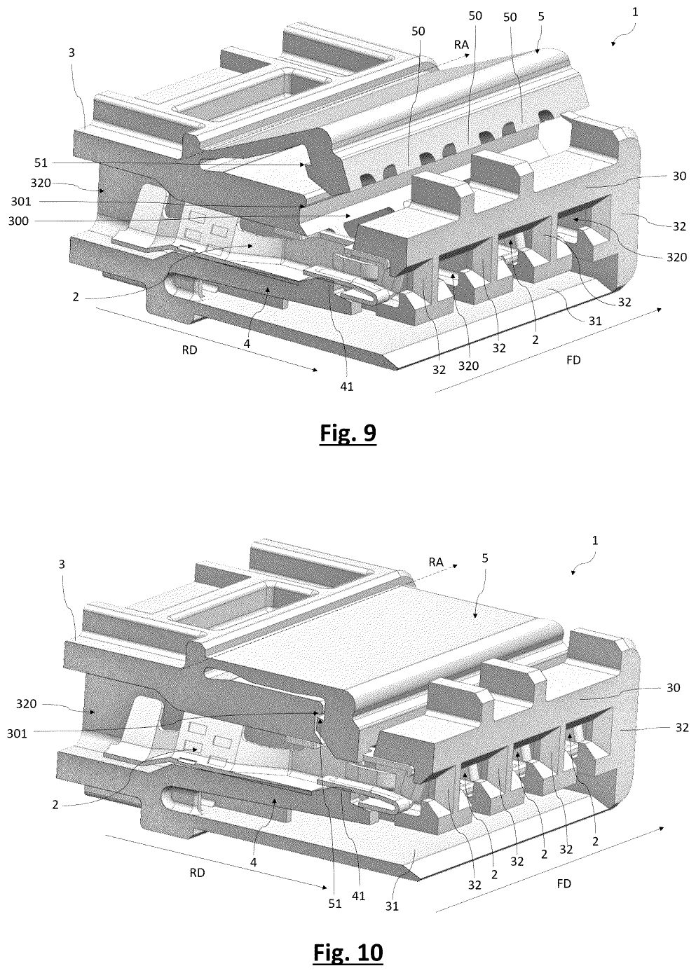

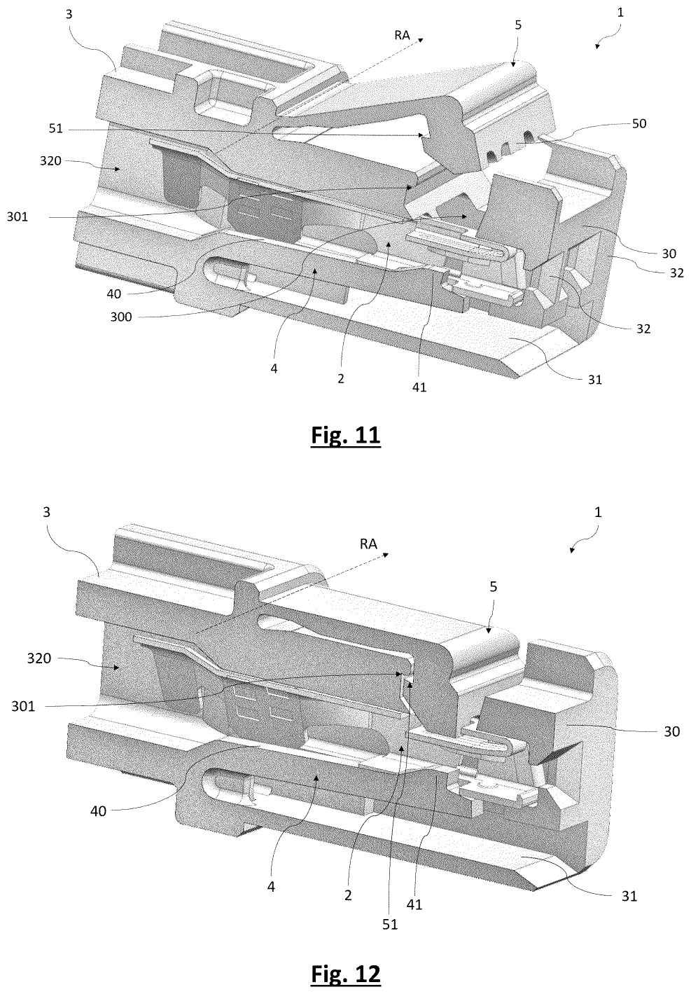

It should be noted that, for the sake of readability and case of understanding, the drawings described above are not necessarily to scale. Elements that are identical or provide the same function carry the same reference numbers for the various embodiments, for the sake of simplicity.

### DETAILED DESCRIPTION

One aspect of the disclosure is an electrical connector I including a set of electrical terminals 2. Each electrical terminal 2 includes opposing first and second surfaces 20, 21 having first and second locking holes 200, 210 respectively. Electrical connector 1 also includes a housing 3, having a chamber arranged to receive the set of electrical terminals 2 along a reception direction RD. The chamber has a top wall 30, a bottom wall 31, and side walls 32. The side walls 32 are arranged successively inside the chamber in a first direction FD perpendicular to the reception direction RD to define locations 320. Each location 320 is dedicated for one electrical terminal 2 of the set. The top wall 30 has an opening 300 arranged to allow access to the locations 320. Each location 320 has a latch 4 designed to cooperate with both the first and second locking holes 200, 210 to hold the corresponding electrical terminal 2 in position along the reception direction RD. The term “latch” as used herein means a flexible arm (e.g., a cantilever member) able to flex when the retainer is moved from the unlocked position to the locked position and vice versa. The latch 4 extends over the bottom wall 31 in the corresponding location 320. A retainer 5 is pivotally mounted on the top wall 30 and is moveable about a rotating axis RA parallel to the first direction FD. Retainer 5 is moveable between a locked position in which the retainer 5 is engaged in the opening 300 and an unlocked position in which the retainer 5 is disengaged from the opening 300. The retainer 5 has protrusions 50 that are designed to cooperate with both the first and second locking holes 200, 210 so that the retainer 5 in the locked position holds in position the set of electrical terminals 2 in the first direction FD.

### Electrical Terminals

Each electrical terminal 2 includes opposing first and second surfaces 20, 21 having first and second locking holes 200, 210, respectively. Each electrical terminal 2 of the set extends along a longitudinal axis LA. The first and second locking holes 200, 210 of each electrical terminal 2 advantageously have a rectangular longitudinal section along the longitudinal axis LA. Each electrical terminal 2 may be designed for crimping onto a conductor of a wire.

### Housing

Housing 3 is made of a dielectric material, preferably a molded plastic, for example polyamide.

### Chamber

The chamber is arranged to receive the set of electrical terminals 2 along a reception direction RD, preferably a horizontal direction. The chamber has opposing top and bottom walls 30, 31 joined by side walls 32. The side walls 32 are arranged successively inside the chamber in a first direction FD perpendicular to the reception direction RD, the first direction FD being preferably a horizontal direction.

The top wall 30, the bottom wall 31 and the side walls 32 delimit locations 320. Each location 320 is dedicated for one electrical terminal 2 of the set. In other words, a single electrical terminal 2 occupies a single location 320. Each location 320 is a cavity formed in the housing 3 extending along the reception direction RD.

The top wall 30 has an opening 300 that is arranged and configured to allow access to locations 320. Opening 300 is sized and shaped to receive the part of the retainer 5 including the protrusions 50 in the locked position.

The top wall 30 advantageously includes a supporting edge 301 which extends along one edge of the opening 300. The supporting edge 301 extends along a direction parallel to the first direction FD.

The chamber advantageously includes opposing first and second ends FE, SE along the reception direction RD. The first end FE is a reception end advantageously designed to receive the set of electrical terminals 2. The second end SE is a mating end advantageously designed to mate the set of electrical terminals 2 with corresponding terminals.

### Latches

Each location 320 has a latch 4 designed to cooperate with both the first and second locking holes 200, 210 to hold the corresponding electrical terminal 2 in position in the reception direction RD. The latch 4 extends over the bottom wall 31 in the corresponding location 320. The latch 4 equipping each location 320 advantageously includes a guiding surface 40 which is arranged on the bottom wall 31 to guide the corresponding electrical terminal 2 along the reception direction RD and a stop element 41 and arranged on the guiding surface 40 to cooperate with both the first and second locking holes 200, 210 so as to lock the corresponding electrical terminal 2 in translation along the reception direction RD.

The guiding surface 40 advantageously has a raising slope toward the reception direction RD. The stop element 41 may be designed as a protrusion extending above the guiding surface 40. The shape of the protrusion of the stop element 41 is designed to cooperate with both the first and second locking holes 200, 210 to lock the corresponding electrical terminal 2 in translation along the reception direction RD.

The latch 4 is advantageously in the form of a flexible arm (e.g., a cantilever member) able to flex when retainer 5 is moved from the unlocked position to the locked position and vice versa.

### Retainer

The retainer 5 is pivotally mounted on the top wall 30 about a rotating axis RA extending parallel to the first direction FD. The rotating axis RA is preferably a horizontal axis. Retainer 5 is pivotally mounted on the top wall 30 about the rotating axis RA and is moveable between a locked position in which retainer 5 is engaged in the opening 300 and an unlocked position in which the retainer 5 is disengaged from the opening 300.

The retainer 5 is advantageously elastically deformable to allow bending about the rotating axis RA between the locked position and the unlocked position. In other words, the retainer 5 is hinged on the top wall 30 about a rotating axis RA parallel to the first direction FD. The term “elastically deformable” as used herein means that the retainer is made of a material that can be deformed reversibly under the action of mechanical stress (below the elastic limit), i.c., the material can return to its initial shape when mechanical stress ceases.

The retainer 5 has protrusions 50 that are designed to cooperate with both the first and second locking holes 200, 210 so that the retainer 5 holds the set of electrical terminals 2 in position in the first direction FD when in the locked position. In this respect, protrusions 50 are advantageously formed in retainer 5 by material recesses to delimit protrusions 50.

The protrusions 50 are arranged to advantageously face the latches 4 when the retainer 5 is in a locked position. The protrusions 50 are advantageously at a distance from the latches 4 when the retainer 5 is in the locked position. The protrusions 50 advantageously have a rectangular cross-section along the reception direction RD when the retainer 5 is in the locked position.

The retainer 5 advantageously includes a shoulder 51 arranged to rest against the supporting edge 301 when the retainer 5 is in the locked position. The shoulder 51 extends along a direction parallel to the first direction FD.

### Example Application

The set of electrical terminals 2 includes a first and a second subset of electrical terminals 2. Each electrical terminal 2 of the first subset is held in position in the reception direction RD by the corresponding latch 4 cooperating with the first locking hole 200. Each electrical terminal of the second subset is held in position in the reception direction RD by the corresponding latch 4 cooperating with the second locking hole 210.

The retainer 5 in the locked position holds in position the first subset of electrical terminals 2 in the first direction FD by the protrusions 50 cooperating with the second locking holes 210. The retainer 5 holds in position the second subset of electrical terminals 2 in the first direction FD when in the locked position because the protrusions 50 cooperate with the first locking holes 200.

While the invention has been described with reference to an exemplary embodiment(s), it will be understood by those skilled in the art that various changes may be made, and equivalents may be substituted for elements thereof without departing from the scope of the invention. In addition, many modifications may be made to configure a particular situation or material to the teachings of the invention without departing from the essential scope thereof. Therefore, it is intended that the invention is not limited to the disclosed embodiment(s), but that the invention will include all embodiments falling within the scope of the appended claims.

As used herein, ‘one or more’ includes a function being performed by one element, a function being performed by more than one element, e.g., in a distributed fashion, several functions being performed by one element, several functions being performed by several elements, or any combination of the above.

It will also be understood that, although the terms first, second, etc., are, in some instances, used herein to describe various elements, these elements should not be limited by these terms. These terms are only used to distinguish one element from another. For example, a first contact could be termed a second contact, and, similarly, a second contact could be termed a first contact, without departing from the scope of the various described embodiments. The first contact and the second contact are both contacts, but they are not the same contact.

The terminology used in the description of the various described embodiments herein is for the purpose of describing particular embodiments only and is not intended to be limiting. As used in the description of the various described embodiments and the appended claims, the singular forms “a”, “an”, and “the” are intended to include the plural forms as well, unless the context clearly indicates otherwise. It will also be understood that the term “and/or” as used herein refers to and encompasses any and all possible combinations of one or more of the associated listed items. It will be further understood that the terms “includes,” “including,” “comprises,” and/or “comprising,” when used in this specification, specify the presence of stated features, integers, steps, operations, elements, and/or components, but do not preclude the presence or addition of one or more other features, integers, steps, operations, elements, components, and/or groups thereof.

As used herein, the term “if” is, optionally, construed to mean “when” or “upon” or “in response to determining” or “in response to detecting,” depending on the context. Similarly, the phrase “if it is determined” or “if [a stated condition or event] is detected” is, optionally, construed to mean “upon determining” or “in response to determining” or “upon detecting [the stated condition or event]” or “in response to detecting [the stated condition or event],” depending on the context.

Additionally, while terms of ordinance or orientation may be used herein these elements should not be limited by these terms. All terms of ordinance or orientation, unless stated otherwise, are used for purposes distinguishing one element from another, and do not denote any particular order, order of operations, direction or orientation unless stated otherwise.

1. An electrical connector, comprising:
a set of electrical terminals, each electrical terminal defining opposing first and second surfaces having first and second locking holes respectively;
a housing having a chamber arranged to receive the set of electrical terminals along a reception direction, the chamber having a top wall, a bottom wall, and side walls; the side walls are arranged successively inside the chamber in a first direction perpendicular to the reception direction to define locations, each location is dedicated for one electrical terminal of the set of electrical terminals, the top wall having an opening arranged to allow access to the locations, each location having a latch designed to cooperate with both the first and second locking holes so as to hold a corresponding electrical terminal in position in the reception direction, the latch extending over the bottom wall in the corresponding location; and
a retainer pivotally mounted on the top wall about a rotating axis parallel to the first direction between a locked position, wherein the retainer is engaged in the opening an unlocked position and wherein the retainer is disengaged from the opening, the retainer having protrusions designed to cooperate with both the first and second locking holes so that the retainer in the locked position holds in position the set of electrical terminals in the first direction.

2. The electrical connector according to claim 1, wherein the protrusions are arranged to face the latches when the retainer is in the locked position.

3. The electrical connector according to claim 1, wherein the protrusions are at a distance from the latches when the retainer is in the locked position.

4. The electrical connector according to claim 1, wherein the protrusions have a rectangular cross-section along the reception direction when the retainer is in the locked position.

5. The electrical connector according to claim 1, wherein the retainer is elastically deformable to allow bending about the rotating axis between the locked position and the unlocked position.

6. The electrical connector according to claim 1, wherein the top wall comprises a supporting edge and wherein the retainer comprises a shoulder arranged to rest against the supporting edge when the retainer is in the locked position.

7. The electrical connector according to claim 1, wherein the latch equipping each location comprises a guiding surface, arranged on the bottom wall to guide the corresponding electrical terminal along the reception direction and a stop element (41), arranged on the guiding surface to cooperate with both the first and second locking holes so as to lock the corresponding electrical terminal in translation along the reception direction.

8. The electrical connector according to claim 7, wherein the guiding surface has a raising slope toward the reception direction.

9. The electrical connector according to claim 1, wherein each electrical terminal of the set of electrical terminals extends along a longitudinal axis and wherein the first and second locking holes of each electrical terminal have a rectangular longitudinal section along the longitudinal axis.

10. The electrical connector according to claim 1, wherein the chamber comprises opposing first and second ends along the reception direction, wherein the first end is a reception end designed to receive the set of electrical terminals, and wherein the second end is a mating end designed to mate the set of electrical terminals with corresponding terminals.

11. The electrical connector according to claim 1, wherein the set of electrical terminals comprises a first and a second subset of electrical terminals, wherein each electrical terminal of the first subset is held in position in the reception direction by the corresponding latch cooperating with the first locking hole, wherein each electrical terminal of the second subset is held in position in the reception direction by the corresponding latch cooperating with the second locking hole, wherein the retainer in the locked position holds in position the first subset of electrical terminals in the first direction by the protrusions cooperating with the second locking holes, and wherein the retainer in the locked position holds in position the second subset of electrical terminals in the first direction by the protrusions cooperating with the first locking holes.
